(19) United States
(12) Patent Application Publication
(10) Pub. No.: US 2026/0073197 A1
(43) Pub. Date: Mar. 12, 2026

(54) ADAPTIVE GENERATIVE KNOWLEDGE DISTILLATION FRAMEWORK FOR CONTINUOUS MULTI-MODEL LEARNING AND CROSS-DOMAIN KNOWLEDGE TRANSFER

(71) Applicants: Avinash Reddy Segireddy, Ashburn, VA (US); Kushvanth Chowdary Nagabhyru, Herndon, VA (US); Anil Lokesh Gadi, Frisco, TX (US); Lahari Pandiri, Holly Springs, NC (US); Srinivasarao Paleti, Hackensack, NJ (US); Botlagunta Preethish Nandan, Norwalk, CT (US); Balaji Adusupalli, Hackensack, NJ (US); Hara Krishna Reddy Koppolu, Cary, NC (US); Jeevani Singireddy, Temecula, CA (US); Raviteja Meda, Strongsville, OH (US)

(72) Inventors: Avinash Reddy Segireddy, Ashburn, VA (US); Kushvanth Chowdary Nagabhyru, Herndon, VA (US); Anil Lokesh Gadi, Frisco, TX (US); Lahari Pandiri, Holly Springs, NC (US); Srinivasarao Paleti, Hackensack, NJ (US); Botlagunta Preethish Nandan, Norwalk, CT (US); Balaji Adusupalli, Hackensack, NJ (US); Hara Krishna Reddy Koppolu, Cary, NC (US); Jeevani Singireddy, Temecula, CA (US); Raviteja Meda, Strongsville, OH (US)

(21) Appl. No.: 19/389,116

(22) Filed: Nov. 14, 2025

(51) Int. Cl. G06N 3/0475; G06N 3/092

(52) U.S. Cl. CPC G06N 3/0475; G06N 3/092

(57) ABSTRACT

The invention provides an Adaptive Generative Knowledge Distillation Framework for Continuous Multi-Model Learning and Cross-Domain Knowledge Transfer. The system integrates a generative memory module, adaptive distillation engine, meta-optimization controller, and cross-domain alignment unit to achieve scalable, privacy-preserving, and domain-invariant learning. By generating synthetic representations of prior knowledge and dynamically aggregating multi-teacher soft targets, the invention prevents catastrophic forgetting and enables seamless knowledge transfer across tasks and environments. Applications include federated learning, autonomous systems, healthcare AI, and edge-cloud robotics.

### TECHNICAL FIELD

The present invention relates to artificial intelligence and machine learning, and more particularly to a generative knowledge distillation system designed to enable continuous learning across multiple models and domains. The invention integrates generative modeling, teacher-student architectures, and adaptive optimization to achieve scalable, non-catastrophic, and transferable learning in multi-model environments.

### BACKGROUND OF THE INVENTION

Traditional deep learning systems are limited by catastrophic forgetting, where new task training overwrites previously learned information. Knowledge distillation (KD) has emerged as a solution, wherein a student network learns from the soft outputs of a teacher network to retain and transfer information. However, existing KD techniques face challenges in multi-model and multi-domain environments, especially when the number of models grows dynamically or when data from past tasks is unavailable due to privacy or storage constraints.

Existing generative distillation methods often rely on static teacher-student pairs or single-domain datasets, lacking the ability to dynamically generate synthetic representations of prior knowledge for continuous adaptation. Moreover, when multiple pre-trained models contribute to collective learning, the aggregation of diverse knowledge becomes inefficient due to inconsistencies in feature representations, loss functions, and model architectures.

Therefore, there is a need for an adaptive generative distillation framework that enables dynamic multi-teacher knowledge fusion and generative synthesis of data distributions from prior tasks

### SUMMARY OF THE INVENTION

The present invention provides a Generative Knowledge Distillation System that integrates generative adversarial modeling, meta-learning, and multi-teacher distillation mechanisms to enable continuous, scalable, and domain-adaptive learning across multiple neural networks.

The system includes:
1. Generative Memory Module (GMM) that synthesizes pseudo-data representations from latent knowledge embeddings of prior models.
2. Adaptive Distillation Engine (ADE) that aggregates soft target distributions from multiple teachers and transfers them to a unified student network.
3. Meta-Optimization Controller (MOC) that dynamically adjusts learning rates, weights, and distillation temperatures based on feedback from generative and discriminative loss metrics.
4. Cross-Domain Alignment Unit (CDAU) that harmonizes latent spaces between diverse models trained on different domains using contrastive and manifold alignment techniques.

The invention allows a continuous multi-model learning pipeline where newly trained models contribute back to the generative memory, thus evolving the knowledge base without storing historical data.

This framework is applicable in numerous domains such as autonomous vehicles, federated learning systems, medical diagnostics, financial analytics, and adaptive robotics, where models must learn incrementally and collaboratively without data redundancy or privacy compromise.

### BRIEF DESCRIPTION OF THE DRAWINGS

The objectives as described above as well as the uniqueness of the proposed technology along with its advantages are better appreciated by referring to the following illustrative and non-limiting detailed description of the present invention along with the following schematic diagrams, wherein:

FIG. 1 illustrates overall system architecture according to one embodiment of the invention.

The drawings described herein are for illustration purposes only and are not intended to limit the scope of the present invention in any way.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

According to one embodiment of the invention, the present disclosure relates to a generative knowledge distillation system designed to achieve continuous, adaptive, and multi-domain learning across heterogeneous machine learning models.

The framework integrates generative modeling, meta-learning, and distillation fusion in a unified architecture that eliminates catastrophic forgetting, enables privacy-preserving knowledge transfer, and facilitates efficient model evolution.

The system operates as a self-evolving learning pipeline where each model contributes distilled knowledge that is transformed into a generative latent space. The latent representations are continuously synthesized into pseudo-data used for training future student models, enabling lifelong learning without dependence on raw datasets.

Knowledge distillation (KD) traditionally involves transferring knowledge from a large teacher model to a smaller student model. However, when multiple teachers from diverse domains contribute knowledge, the distillation process becomes unstable and domain-biased.

The invention introduces a generative distillation paradigm, where knowledge is represented not only by soft labels but also by synthetic data distributions generated by a Generative Memory Module (GMM). This generative component acts as a knowledge preserver, reconstructing the essence of prior tasks in data-free conditions.

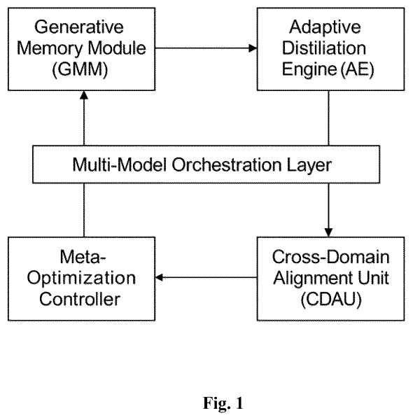

Referring to FIG. 1, the system comprises four interlinked functional modules:
1. Generative Memory Module (GMM)
2. Adaptive Distillation Engine (ADE)
3. Meta-Optimization Controller (MOC)
4. Cross-Domain Alignment Unit (CDAU)

A Multi-Model Orchestration Layer (MMOL) supervises coordination, model registration, and synchronization across distributed nodes. Each module performs distinct but interdependent operations to enable continuous, autonomous learning across models.

Generative Memory Module (GMM): According to one embodiment of the invention, the GMM serves as the virtual memory of the framework. Instead of storing raw datasets, it encodes latent feature embeddings (mean μ and variance σ) derived from previously trained teacher models.

A Variational Autoencoder (VAE) or Generative Adversarial Network (GAN) is employed to generate synthetic pseudo-samples that replicate historical task distributions.

The process includes:
Encoding Phase: Extract feature vectors fᵢ from intermediate layers of teacher models. Encode them into latent vectors zᵢ through probabilistic encoders.
Latent Storage: Store zᵢ in a Knowledge Embedding Bank (KEB) with metadata describing task identity, domain, and timestamp.
Decoding Phase: When required, decode Zito generate synthetic samples \hat{x}ᵢ for replay and distillation.

This mechanism allows data-free continual learning even when original datasets are inaccessible.

Adaptive Distillation Engine (ADE): According to another embodiment of the invention, the ADE aggregates knowledge from multiple teacher networks T₁, T₂ . . . , Tₙ and produces a unified soft target distribution Pₜ.

Each teacher contributes logit outputs zᵢ which are temperature-scaled using softmax with parameter τᵢ. The adaptive weighting unit computes relevance weights wᵢ based on confidence, domain similarity, and task recency.

The fused distribution is expressed as:

$${P}_{t} = {\sum }_{i} {w}_{i} \cdot softmax ( \frac{{z}_{i}}{{τ}_{i}} )$$

The student model S minimizes a hybrid loss function:

$${L}_{total} = α {L}_{soft} ( S , {P}_{t} ) + β {L}_{hard} ( S , {Y}_{new} ) + γ {L}_{gen} ( S , \hat{X} )$$

where L_{gen} enforces consistency with generative pseudo-samples.

This fusion enables balanced learning from both new and old tasks, thereby preventing catastrophic forgetting.

where L_{gen} enforces consistency with generative pseudo-samples.

This fusion enables balanced learning from both new and old tasks, thereby preventing catastrophic forgetting.

Meta-Optimization Controller (MOC): The MOC dynamically tunes hyperparameters and orchestrates the learning dynamics across the entire pipeline.

It leverages reinforcement learning to adjust:
Learning rate η
Distillation temperature τ
Weighting factors α, β, γ
Teacher importance coefficients wᵢ

A reward function Rₜ evaluates validation accuracy, reconstruction loss, and stability score. The controller updates policies using gradient ascent:

$$θ ← θ + λ {∇}_{θ} {R}_{t}$$

By learning an adaptive optimization policy, the MOC ensures that the system self-adjusts to evolving data streams and model updates, achieving meta-stability in multi-model learning. Cross-Domain Alignment Unit (CDAU): Cross-domain knowledge transfer requires harmonizing heterogeneous feature spaces. The CDAU applies contrastive domain alignment and adversarial discrimination techniques to ensure latent representations from different domains occupy a shared manifold.

A domain discriminator D is trained adversarially to distinguish domain labels, while the encoder E minimizes this discrimination, achieving invariance.

The loss is expressed as:

$${L}_{CDAU} = {L}_{contrastive} + {λ}_{adv} {L}_{adv}$$

This ensures that even if teachers originate from unrelated tasks (e.g., vision, text, finance), the distilled student model can generalize across domains.

Multi-Model Orchestration Layer (MMOL): According to one embodiment, MMOL maintains a registry of active and historical models, recording metadata such as task identity, version, performance score, and feature embedding indices. It manages asynchronous model updates, ensuring that teacher models contribute sequentially or concurrently without synchronization conflicts. MMOL also controls the feedback loop between the generative module and the knowledge embedding bank, allowing continuous embedding evolution and avoiding redundant generation.

### Embodiment 1: Federated Healthcare Diagnostics

Hospitals train local models on private patient data.

Each acts as a teacher contributing encoded latent features to the central GMM.

Synthetic medical samples are generated for training a unified global model without sharing sensitive data, ensuring HIPAA-compliant privacy preservation.

### Embodiment 2: Autonomous Vehicle Network

Each autonomous car trains a perception model. The ADE aggregates their knowledge under varying weather and lighting conditions.

The GMM generates pseudo-road scenes for retraining new vehicles, allowing continual fleet adaptation.

### Embodiment 3: Financial Fraud Detection

Banks use localized fraud detection models. The system distills cross-institutional fraud patterns using generated transaction features, leading to improved generalization on unseen fraud scenarios.

### Embodiment 4: Edge-Cloud Robotics

Edge robots locally learn manipulation skills and distill experience embeddings to the cloud.

The cloud server acts as the student model, continuously updating a meta-policy distributed back to the robots.

### Embodiment 5: Educational Adaptive Systems

Multiple AI tutors learn from diverse learning behaviors.

The global student model integrates this knowledge through generative distillation, creating personalized learning pathways for new students.

Data-Free Distillation Scenario: In data-sensitive environments, regulatory constraints may prevent data storage. The invention addresses this by generating synthetic, anonymized representations from latent embeddings, effectively bypassing the need for original samples while maintaining learning fidelity.

Self-Evolving Meta-Learning Loop: Every newly trained student model becomes a teacher in subsequent cycles. The MOC ensures this recursive evolution maintains global stability by recalibrating task weights and embedding priorities based on novelty detection metrics. This feedback cycle allows the system to operate indefinitely as a living AI ecosystem that grows more intelligent over time.

Network Implementation Details: According to one embodiment, the generator employs a residual VAE-GAN hybrid with perceptual loss regularization.

Applications: Applicable industries include:
Healthcare diagnostics (multi-modal imaging)
Financial analytics (risk scoring, fraud detection)
Smart manufacturing (predictive maintenance)
Cybersecurity (threat intelligence fusion)
Defense AI (autonomous multi-sensor learning)
Education technology (adaptive e-learning systems)

### INDUSTRIAL APPLICABILITY

The invention provides a foundation for lifelong AI systems capable of integrating knowledge from distributed, heterogeneous sources. Industries deploying continuous intelligence—such as telecommunication, healthcare, autonomous vehicles, and fintech—can utilize this framework for self-updating AI models without retraining from scratch.

It will be recognized that the above described subject matter may be embodied in other specific forms without departing from the scope or essential characteristics of the disclosure. Thus, it is understood that, the subject matter is not to be limited by the foregoing illustrative details, but it is rather to be defined by the appended claims.

While specific embodiments of the invention have been shown and described in detail to illustrate the novel and inventive features of the invention, it is understood that the invention may be embodied otherwise without departing from such principles.

What is claimed is:

1. A generative knowledge distillation system for continuous multi-model learning comprising: embeddings of prior models;

2. The system as claimed in claim 1, wherein the generative memory module comprises a variational autoencoder or generative adversarial network trained to reconstruct task-specific feature maps.

3. The system as claimed in claim 1, wherein the adaptive distillation engine applies temperature-scaled softmax fusion of multiple teacher logits based on confidence weights.

4. The system as claimed in claim 1, wherein the meta-optimization controller utilizes reinforced meta-learning to optimize loss weighting, learning rate, and temperature.

5. The system as claimed in claim 1, wherein the cross-domain alignment unit employs contrastive learning and adversarial domain discrimination to achieve domain-invariant representations.

6. The system as claimed in claim 1, further comprising a knowledge embedding bank for storing encoded latent feature vectors representing prior model knowledge.

7. The system as claimed in claim 1, wherein pseudo-data generated by the generative memory module is used as training input for subsequent student models to prevent catastrophic forgetting.

8. The system of claim 1, wherein the orchestration layer manages asynchronous model updates in distributed or federated environments.

9. The system of claim 1, wherein the generative knowledge distillation enables privacy-preserving model fusion without access to original training data.

10. The system of claim 1, wherein the framework enables self-evolving learning cycles for continuous adaptation to new tasks.
